(19) United States
(12) Patent Application Publication
(10) Pub. No.: US 2025/0390611 A1
(43) Pub. Date: Dec. 25, 2025

(54) VALIDATING DATA STRUCTURES FOR TRANSMISSION ACROSS NETWORKED ENVIRONMENTS

(71) Applicant: State Farm Mutual Automobile Insurance Company, Bloomington, IL (US)

(72) Inventor: Muthukumaran Rathinasabapathy, Bloomington, IL (US)

(73) Assignee: State Farm Mutual Automobile Insurance Company, Bloomington, IL (US)

(21) Appl. No.: 18/752,390

(22) Filed: Jun. 24, 2024

(51) Int. Cl. G06F 21/64

(52) U.S. Cl. CPC G06F 21/64

(57) ABSTRACT

Presented herein are systems and methods of validating data to be transmitted across networked environments. A computing system may receive a data structure comprising a plurality of fields and a corresponding plurality of values according to a data type of a plurality of data types for a policy. The plurality of values may have a subset of values generated via a user interface. The computing system may select, from a plurality of configurations, a configuration based on the data type of the data structure. The computing system may identify, from the plurality of fields, a field in accordance with the configuration. The computing system may determine that a value of the plurality of values corresponding to the field is not valid. The computing system may generate an indication identifying the data structure as restricted from transmission to the network due to the value of the field.

### BACKGROUND

A sender device may transmit data to a recipient device as part of a request to execute a function. The recipient device may process the data of the request in executing the function.

### SUMMARY

Aspects of the present disclosure are directed to systems for validating data to be transmitted across networked environments. The system may include one or more processors coupled with memory of a policy administration system. The one or more processors may receive a data structure comprising a plurality of fields and a corresponding plurality of values according to a data type of a plurality of data types for a policy. The plurality of values may have a subset of values generated via a user interface provided by the policy administration system. The one or more processors may select, from a plurality of configurations corresponding to the plurality of data types, a configuration based on the data type of the data structure. The configuration may identify at least one of the plurality of fields to be validated for transmission to a network. The one or more processors may identify, from the plurality of fields of the data structure, a field in accordance with the configuration. The one or more processors may determine that a value of the plurality of values corresponding to the field is not valid. The one or more processors may generate an indication identifying the data structure defining the policy as restricted from transmission to the network due to the value of the field, responsive to determining that the value is not valid. The one or more processors may generate an action, responsive to the indication to restrict transmission of the data structure to the network.

In some embodiments, the one or more processors may determine that a second value of a second plurality of values corresponding to a second field of a second data structure defining a second policy is valid. In some embodiments, the one or more processors may generate a second indication identifying the second data structure defining the second policy as permitted to be transmitted to the network, responsive to determining that the second value is valid. In some embodiments, the one or more processors may perform a second action, responsive to the second indication to permit transmission of the second data structure to the network.

In some embodiments, the one or more processors may execute a request associated with the policy, in accordance with the data structure defining the policy. In some embodiments, the one or more processors may transmit, to a computing device, the second data structure defining the second policy. In some embodiments, the one or more processors may select the configuration identifying a first request type for which the field of the plurality of fields is to be validated for transmission. In some embodiments, the one or more processors may determine that a second request type associated with the data structure matches the first request type identified by the policy. In some embodiments, the one or more processors may identify the field, responsive to determining that the second request type matches the first request type.

In some embodiments, the one or more processors may provide, via the user interface, the indication identifying the field of the plurality of fields corresponding to the value as invalid. In some embodiments, the one or more processors may restrict, from transmission to a computing device, transmission of the data structure defining the policy. In some embodiments, the one or more processors may receive the data structure comprising (i) the plurality of fields including (a) a first field and (b) a second field and (ii) the corresponding plurality of values including (a) a first value corresponding to the first field and (b) a second value corresponding to the second field, the first value inputted via the user interface. The second value may be generated using the first value in accordance with the second field.

In some embodiments, the one or more processors may identify, from the plurality of values of the data structure, a second value corresponding to second field of the plurality of fields in accordance with the configuration. The second value may be part of the subset of values. In some embodiments, the one or more processors may determine that the value is valid based on consistency between the value and the second value. In some embodiments, the one or more processors may determine that value of the plurality of values corresponds to a null value.

In some embodiments, the one or more processors may identify, from the plurality of fields in accordance with the configuration, the field corresponding to at least one of a remaining subset of values of the plurality of values generated using one or more of the subset of values. In some embodiments, the one or more processors may receive the data structure comprising the plurality of fields and the corresponding plurality of values for the policy associated with a vehicle. The plurality of fields may include at least one field identifying the vehicle.

Other aspects of the present disclosure are directed to a method of validating data to be transmitted across networked environments. The method may include receiving, by one or more processors of a policy administration system, a data structure comprising a plurality of fields and a corresponding plurality of values according to a data type of a plurality of data types for a policy. The plurality of values may have a subset of values generated via a user interface provided by the policy administration system. The method may include selecting, by the one or more processors, from a plurality of configurations corresponding to the plurality of data types, a configuration based on the data type of the data structure. The configuration may identify at least one of the plurality of fields to be validated for transmission to a network. The method may include identifying, by the one or more processors, from the plurality of fields of the data structure, a field in accordance with the configuration. The method may include determining, by the one or more processors, that a value of the plurality of values corresponding to the field is not valid. The method may include generating, by the one or more processors, an indication identifying the data structure defining the policy as restricted from transmission to the network due to the value of the field, responsive to determining that the value is not valid. The method may include generating, by the one or more processors, an action, responsive to the indication to restrict transmission of the data structure to the network.

In some embodiments, the method may include determining, by the one or more processors, that a second value of a second plurality of values corresponding to a second field of a second data structure defining a second policy is valid. In some embodiments, the method may include generating, by the one or more processors, a second indication identifying the second data structure defining the second policy as permitted to be transmitted to the network, responsive to determining that the second value is valid. In some embodiments, the method may include performing, by the one or more processors, a second action, responsive to the second indication to permit transmission of the second data structure to the network.

In some embodiments, the method may include executing, by the one or more processors, a request associated with the policy, in accordance with the data structure defining the policy. In some embodiments, the method may include transmitting, by the one or more processors, to a computing device, the second data structure defining the second policy. In some embodiments, the method may include selecting, by the one or more processors, the configuration identifying a first request type for which the field of the plurality of fields is to be validated for transmission. In some embodiments, the method may include determining, by the one or more processors, that a second request type associated with the data structure matches the first request type identified by the policy. In some embodiments, the method may include identifying, by the one or more processors, the field, responsive to determining that the second request type matches the first request type.

In some embodiments, the method may include providing, by the one or more processors, via the user interface, the indication identifying the field of the plurality of fields corresponding to the value as invalid. In some embodiments, the method may include restricting, by the one or more processors, from transmission to a computing device, transmission of the data structure defining the policy. In some embodiments, the method may include receiving, by the one or more processors, the data structure comprising (i) the plurality of fields including (a) a first field and (b) a second field and (ii) the corresponding plurality of values including (a) a first value corresponding to the first field and (b) a second value corresponding to the second field, the first value inputted via the user interface. The second value may be generated using the first value in accordance with the second field.

In some embodiments, the method may include identifying, by the one or more processors, from the plurality of values of the data structure, a second value corresponding to second field of the plurality of fields in accordance with the configuration. The second value may be part of the subset of values. In some embodiments, the method may include determining, by the one or more processors, that the value is valid based on consistency between the value and the second value. In some embodiments, the method may include determining, by the one or more processors, that value of the plurality of values corresponds to a null value.

In some embodiments, the method may include identifying, by the one or more processors, from the plurality of fields in accordance with the configuration, the field corresponding to at least one of a remaining subset of values of the plurality of values generated using one or more of the subset of values. In some embodiments, the method may include receiving, by the one or more processors, the data structure comprising the plurality of fields and the corresponding plurality of values for the policy associated with a vehicle. The plurality of fields may include at least one field identifying the vehicle.

Other aspects of the present disclosure are directed to a non-transitory computer readable medium have instructions stored thereon that, when executed by at least one processor, cause the at least one processor to perform operation comprising: receiving a data structure comprising a plurality of fields and a corresponding plurality of values according to a data type of a plurality of data types for a policy. The plurality of values may have a subset of values generated via a user interface provided by the policy administration system. The operations may include selecting, from a plurality of configurations corresponding to the plurality of data types, a configuration based on the data type of the data structure. The configuration may identify at least one of the plurality of fields to be validated for transmission to a network. The operations may include identifying, from the plurality of fields of the data structure, a field in accordance with the configuration. The operations may include determining that a value of the plurality of values corresponding to the field is not valid. The operations may include generating an indication identifying the data structure defining the policy as restricted from transmission to the network due to the value of the field, responsive to determining that the value is not valid. The operations may include generating an action, responsive to the indication to restrict transmission of the data structure to the network.

In some embodiments, the operations may include determining that a second value of a second plurality of values corresponding to a second field of a second data structure defining a second policy is valid. In some embodiments, the operations may include generating a second indication identifying the second data structure defining the second policy as permitted to be transmitted to the network, responsive to determining that the second value is valid. In some embodiments, the operations may include performing a second action, responsive to the second indication to permit transmission of the second data structure to the network.

In some embodiments, the operations may include executing a request associated with the policy, in accordance with the data structure defining the policy. In some embodiments, the operations may include transmitting to a computing device, the second data structure defining the second policy. In some embodiments, the operations may include selecting the configuration identifying a first request type for which the field of the plurality of fields is to be validated for transmission. In some embodiments, the operations may include determining that a second request type associated with the data structure matches the first request type identified by the policy. In some embodiments, the operations may include identifying the field, responsive to determining that the second request type matches the first request type.

In some embodiments, the operations may include providing, via the user interface, the indication identifying the field of the plurality of fields corresponding to the value as invalid. In some embodiments, the operations may include restricting, from transmission to a computing device, transmission of the data structure defining the policy. In some embodiments, the operations may include receiving the data structure comprising (i) the plurality of fields including (a) a first field and (b) a second field and (ii) the corresponding plurality of values including (a) a first value corresponding to the first field and (b) a second value corresponding to the second field, the first value inputted via the user interface. The second value may be generated using the first value in accordance with the second field.

In some embodiments, the operations may include identifying, from the plurality of values of the data structure, a second value corresponding to second field of the plurality of fields in accordance with the configuration. The second value may be part of the subset of values. In some embodiments, the operations may include determining that the value is valid based on consistency between the value and the second value. In some embodiments, the operations may include determining that value of the plurality of values corresponds to a null value.

In some embodiments, the operations may include identifying, from the plurality of fields in accordance with the configuration, the field corresponding to at least one of a remaining subset of values of the plurality of values generated using one or more of the subset of values. In some embodiments, the operations may include receiving the data structure comprising the plurality of fields and the corresponding plurality of values for the policy associated with a vehicle. The plurality of fields may include at least one field identifying the vehicle.

### BRIEF DESCRIPTION OF THE DRAWINGS

The accompanying drawings constitute a part of this specification, illustrate an embodiment, and together with the specification, explain the subject matter of the disclosure.

FIG. 1 depicts a block diagram of a system for validating data to be transmitted across networked environments, in accordance with an illustrative embodiment.

FIG. 2 depicts a block diagram of a process for handling requests including data in the system for validating, in accordance with an illustrative embodiment.

FIG. 3 depicts a block diagram of a process for checking data against configurations in the system for validating, in accordance with an illustrative embodiment.

FIG. 4 depicts a block diagram of a process for executing actions on data in the system for validating, in accordance with an illustrative embodiment.

FIG. 5 depicts a flow diagram of a method of validating data to be transmitted across networked environments, in accordance with an illustrative embodiment.

FIG. 6 is a block diagram of a computing environment according to an example implementation of the present disclosure.

### DETAILED DESCRIPTION

Following below are more detailed descriptions of various concepts related to, and embodiments of, systems and methods for validating data to be transmitted across networked environments. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes systems and methods for validating data to be transmitted across networked environments.

Section B describes a describes a network environment and computing environment which may be useful for practicing various embodiments described herein.

A. Systems and Methods of Validating Data to be Transmitted Across Networked Environments

A policy administration system may communicate enormous volumes of data associated with policies, with agent computing devices and policy processor computing devices. The policy administration system may receive a data structure as part of a request for a policy. The data structure may have been generated via entry of information on the agent computing device. The data structure may include a set of entries (e.g., in the form of field-value pairs) defining the policy, such as an identification of an entity, policy type, and conditions, among others. The policy administration system may process the data structure to record the policy. With the recordation, the policy administration system may transmit the data structure for the policy to a processor computing device for additional processing.

For proper processing, the entries of the data structure should conform with data integrity specifications and include correct and consistent values and format. Incorrect or inconsistent values and format in the entries of the data structure may result in errors on the part of the policy administration system as well as the processor computing device. Data structures lacking data integrity may lead to inability by the policy administration system to process and record the policy. If transmitted downstream to the processor computing device, these data structures may negatively impact the functioning of processor computing device also, resulting in the processor computing device unable to properly process the data structures. Incorrect or inconsistent values may lead to wasted consumption of storage space from storing and maintaining data structures, improper allocation of processor time and resources from processing the data, an expenditure of network bandwidth from communicating incorrect or inconsistent values and formats. Furthermore, the user of the processor computing device may have to exert effort and time to edit incorrect values or fill in missing fields manually and meticulously, leading to degradation of the quality of human-computer interactions (HCl).

These data integrity issues may stem from a variety of sources. For one, data entry errors may be caused by manual entry mistakes (e.g., by the user of the agent computing device), such as typographical errors, missing values for fields, and incorrect formats, among others. For another, some of the entries may be dependent on the values of other entries, and may be incorrectly derived or failed to be populated by the application on the agent computing device using the values of other entries. For example, the data structure for a vehicle policy may include an entry for model identifier of the vehicle identifying a sedan, inputted by the user via a user interface for defining the data structure for the policy. This entry may be used to populate an entry for a vehicle type in the data structure, but the application on the agent computing device may fail to derive the correct value or not generate a value at all. With policies, such data integrity issues may be exacerbated, as precise and accurate information are to be used to properly process data structures associated with such policies.

There may be several approaches at addressing the data integrity issues. One approach to addressing these issues may be to manually identify the source of the data structure and correct the entries of the data structure based on the identified source. Another approach may be to manually fix the data structure entries at the policy administration system, prior to downstream transmission to the processor computing device. Another approach may be to correct the data structure entries while stored and maintained on a database. Another approach may be to correct the logic of the application generating the entries for the data structure. These approaches, however, may be a haphazard measure to address data integrity problems as they arise and may not fully address incomplete or incorrect values or formats of data structures. Furthermore, such measures may be inappropriate with data structures related to policies where there may be dependencies among the values of the data structure.

To address these and other technical challenges, the policy administration system may control transmission of data structures to downstream processor computing devices, by identifying and rectifying instances of data entries that are missing or correct. In ensuring data integrity, the policy administration system may be configured with a set of configurations for a corresponding set of data types (e.g., using an enumeration data type) for policies. The configuration may detail a set of rules defining checks to be performed on the data structures for the policies. For example, the configuration may define which field is to be validated, a condition under which the field is to be validated, a transaction type for which the data structure is to be validated, and error messages to be presented when there is a failure to validate, among others, prior to downstream transmissions. These configurations for data validation may be easily modifiable and interchangeable, without affecting the other functionalities provided by the policy administration system. By using the configurations, the policy administration system can enforce validation rules for a wide variety of types of data structures defining policies in a highly scalable and adaptable manner.

When a transaction request with a data structure for a policy is received, the policy administration system may select a configuration for a data type of the data structure. For example, the policy administration system may select the configuration for a request associated with a vehicle insurance policy, when the data type for the data structure is for such a vehicle insurance policy. With the selection of the configuration, the policy administration system may identify a set of fields to be validated as specified by the configuration. For each field, the policy administration system may find a corresponding value in the data structure and may determine whether the value for the field is valid. A valid value may correspond to a complete value (e.g., a non-null value) or a consistent value (e.g., with respect to a defined subset of other values in the data structure). The policy administration system may repeat the determination over all the fields specified by the configuration.

If all of the values are complete and consistent, the policy administration system may determine that the fields of the data structure are valid. The policy administration system may also generate an indicator identifying that the data structure is permitted to be transmitted downstream to processor computing devices. The policy administration system may also execute the transaction request (e.g., to quote and bind the policy). On the other hand, if any of the values are incomplete or inconsistent, the policy administration system may determine that the data structure is not valid and may identify which fields are invalid (e.g., for having an incomplete or inconsistent value). The policy administration system may generate an indicator identifying that the data structure is restricted from transmission downstream. In addition, the policy administration system may provide information to the agent device identifying which fields of the data structure are invalid. Using the information, the user of the agent device may correct the values of the fields identified as invalid. In some embodiments, the policy administration system may automatically generate corrected values as recommendations to the user of the agent device to accept or reject the automatically generated values.

In this manner, by detecting and rectifying invalid entries within the data structures, the policy administration system may improve the data integrity of the data structures defining policies. From enhancing data integrity, the policy administration system may prevent adverse impacts on other computing devices downstream. The policy administration system may also reduce effort and time spent on troubleshooting invalid data entries by restricting data structures with invalid values from transmission downstream. With the use of the configurations, the policy administration system may decimate or significantly reduce the number of data structures with data integrity issues from being transmitted. As a result, the policy administration system may decrease the consumption of computing resources on the policy administration system itself as well as any downstream processor computing devices that would have otherwise been spent on processing data structures with missing or inconsistent values. The policy administration system may also lower the expenditure of network bandwidth on invalid data structures by controlling which data structures to transmit downstream.

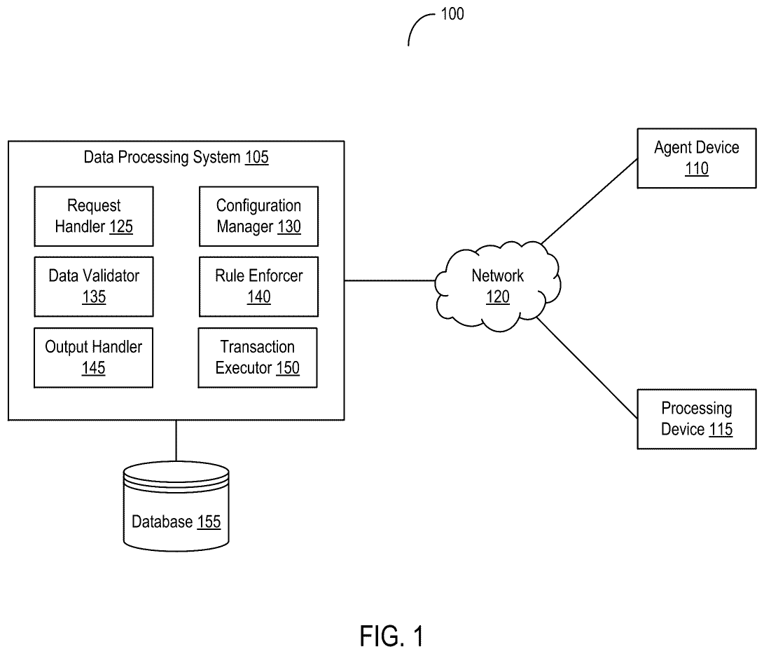

Referring now to FIG. 1, depicted is a block diagram of a system 100 for validating data to be transmitted across networked environments. In brief overview, the system 100 may include at least one data processing system 105, at least one agent device, and at least one processing device 115, communicatively coupled with one another via at least one network 120. The data processing system 105 may include at least one request handler 125, at least one configuration manager 130, at least one data validator 135, at least one rule enforcer 140, at least one output handler 145, at least one transaction executor 150, and at least one database 155, among others. Each of the components in the system 100 as detailed herein may be implemented using hardware (e.g., one or more processors coupled with memory), software (e.g., instructions stored on a computer-readable storage medium), or a combination of hardware and software as detailed herein in Section B.

In further detail, the data processing system 105 (sometimes herein generally referred to as a policy administration system or policy management integrator) may be any computing device including one or more processors coupled with memory and software and capable of performing the various processes and tasks described herein. In some embodiments, the data processing system 105 may be operated by or associated with a policy administrator entity responsible for quoting and binding of polices from agent entities. The data processing system 105 may be in communication with the agent device 110 and the processing device 115, among others. The data processing system 105 may be situated, located, or otherwise associated with at least one server group. The server group may correspond to a data center, a branch office, or a site at which one or more servers corresponding to the data processing system 105 are situated. In some embodiments, the data processing system 105 may be intermediary to the agent device 110 and the processing device 115. For example, data from the agent device 110 may be communicated through the data processing system 105 to the processing device 115.

On the data processing system 105, the request handler 125 may receive and process transaction requests including data structures defining policies. The configuration manager 130 may identify configurations defining rules to check the data structures against. The data validator 135 may determine whether the values associated with the fields of the data structures specified by a given configuration is valid. The rule enforcer 140 may carry out measures based on whether the data structures are valid or invalid. The output handler 145 may generate information regarding the validation of the data structures. The transaction executor 150 may carry out the requests associated with the data structures defining the policy depending on the validation of the data structures.

The data processing system 105 may facilitate, handle, or otherwise provide an instance of policy administration application. The instance may be executed or running on a virtual machine. The virtual machine in turn may be hosted on physical hardware (e.g., one or more hardware processors coupled with memory). The instance may be provided as part of a cloud service, such as an infrastructure as a service (IaaS), a platform as a service (PaaS), or a software as a service (SaaS), among others. The policy administration application may be associated with the same entity (e.g., a first-party) or a different entity (e.g., a third-party application) as the entity associated with the data processing system 105. The policy administration application may administer insurance policies such as Guidewire's PolicyCenter™, Ventiv Policy™, Oracle Insurance Policy Administration™, or InsPro Enterprise™, among others. For example, the policy administration application can be used to intake insurance submissions, process forms associated with the insurance submission, evaluate risks of application, and provide user interface for managing data associated with the insurance policy, among many other functionalities.

The agent device 110 (sometimes herein referred to as a computing device or a client) may be any computing device including one or more processors coupled with memory and software and capable of performing the various processes and tasks described here. In some embodiments, the agent device 110 may be operated by or associated with an agent entity for handling insurance of policy holders. The agent device 110 may be in communication with the data processing system 105 and the processing device 115, among others. The agent device 110 may access the data processing system 105 via an application instance of the policy administration application. For example, upon request, the agent device 110 may be provided with a session of the policy administration application. Using the agent device 110, the agent entity may interact with the user interface elements of the instance presented via the display to access the functionalities and resources hosted by the data processing system 105. In some embodiments, the processing device 115 may be one end of a communication path formed between the agent device 110, through the data processing system 105, and to the processing device 115.

The processing device 115 (sometimes herein referred to as a computing device or downstream device) may be any computing device including one or more processors coupled with memory and software and capable of performing the various processes and tasks described here. In some embodiments, the processing device 115 may be operated by or associated with an entity (e.g., besides the agent entity or the policy administrator entity) for processing policy data, such as a claims management entity, an underwriter entity, a billing and payments manager entity, an analytics entity, a reinsurance entity, or regulatory and compliance management entity, among others. The processing device 115 may be in communication with the data processing system 105 and the agent device 110, among others. In some embodiments, the processing device 115 may be on one end of a communication path formed between the agent device 110, through the data processing system 105, and to the processing device 115.

The database 155 may store and maintain various resources and data associated with the data processing system 105. The database 155 may include a database management system (DBMS) to arrange and organize the data maintained thereon. The database 155 may be in communication with the data processing system 105, the agent device 110, and the processing device 115, among others. The database 155 can interface with the data processing system 105 to store, maintain, and manage policy related data for the policy administration software. For example, the database 155 can store and maintain the policy data using an identifier referencing a respective policy. While running various operations, the data processing system 105 may access the database 155 to retrieve various data therefrom and to write new data thereto.

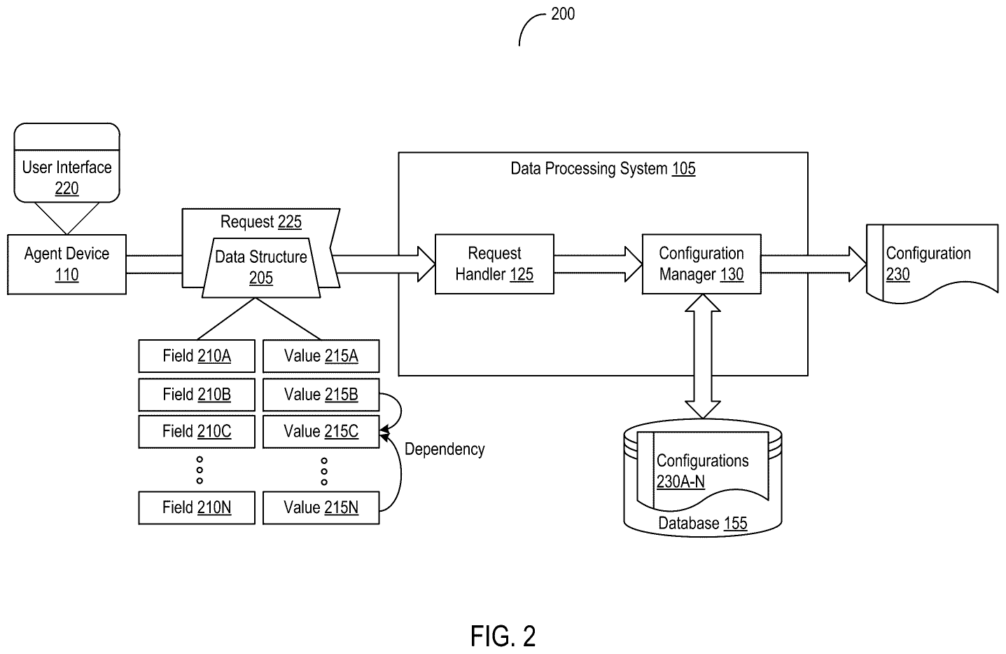

Referring now to FIG. 2, depicted is a block diagram of a process 200 for handling requests including data in the system 100 for validating. The process 200 may include or correspond to operations performed in the system 100 to receive requests including data structures defining policies and to select configurations to check the data structures of the requests. Under the process 200, the agent device 110 may create, produce, or otherwise generate at least one data structure 205. The data structure 205 may specify, identify, or otherwise at least one policy. The data structure 205 may identify or include a set of fields 210A-N (hereinafter generally referred to as fields 210) and a corresponding set of values 215A-N (hereinafter generally referred to as values 215), among others.

In the data structure 205, the set of fields 210 and the corresponding set of values 215 may be in accordance with a data type of a set of data types. The data types may correspond to a type of policy or a type of transaction request for the policy. The type of policy may be at least one of various types of insurance policies and the type of transaction requests may be related to the insurance policy. For example, the type of policy may include, for example, flood, fire, health, home, renter, umbrella, life, travel, disability, pet, boat, or vehicle insurance, among others. The type of transaction request may include, for example, a quoting request (e.g., an initial stage to provide definitions for the insurance policy), a binding request (e.g., to temporarily activate the insurance policy), an issuance request (e.g., to fully activate the insurance policy), or a claim request (e.g., to request for compensation for a loss of a protected asset), among others. The type of policy may also include any other types of policies, for example: a risk management policy to address risks to entities; risk mitigation policy to reduce likelihood of occurrence of a defined event; or a risk protection policies to define countermeasures against various sources of risk, among others. The data type may define the set of fields 210 and the set of values 215 to be included in the data structure 205. In some embodiments, the data type of the data structure 205 may specify or define a formatting for the set of fields 210 and the set of values 215.

Each field 210 (also sometimes herein referred to as a name or key) may correspond at least one type of attribute. The type of attribute may correspond a respective property or aspect of the policy. The type of attribute may include, for example for an insurance policy, an identifier for a request type, an insurer, an identifier for a policy holder, a vehicle identifier, an identifier for the agent entity, a type of insurance, and an identifier for an asset under insurance (e.g., vehicle, building, house, boat, or pet), among others. For a vehicle insurance, the attributes for the field 210 may include or identify, for instance, a liability code, a manufacturer code, a make identifier, a model identifier, a body type, a base value, and telematics, among others. Each field 210 may be associated with a corresponding value 215.

Each value 215 may be associated with a corresponding field 210 and may identify or include data assigned to the corresponding field 210. The value 215 together with the corresponding field may represent or form a data entry for the data structure 205. For instance, for a data entry defining the vehicle insurance policy, the value 215 may identify data for a make, model year, or vehicle weight class, among others. In some embodiments, at least one of the values 215 of a given field 210 in the data structure 205 may be generated by the agent device 110 using a value 215 of at least one other field 210. In the depicted example, the data structure 205 may have the value 215C for the field 210C generated using the value 215B for the field 210B and the value 215N for the field 210N.

In generating the data structure 205, the agent device 110 may display, render, or otherwise provide at least one user interface 220 (e.g., via a display of the agent device 110). The user interface 220 may be provided by the data processing system 105 (or the policy management application provided by the data processing system 105). The user interface 220 may include one or more user interface elements used to define, enter, or otherwise input data for at least a portion of the values 215 of the fields 210 for the data structure 205. For example, using the user interface element of the user interface 220, the agent entity associated with the agent device 110 may input information to form a portion of the values 215 for the corresponding portion of fields 210 of the data structure 205.

In some embodiments, at least one of the values 215 may be generated using another value 215 generated via the user interface 220. For instance, for a house insurance policy, the user interface 220 may include elements for entering the value 215 corresponding to a postal code for an address of the house. The value 215 corresponding to the postal code may be used to generate other values 215 for other fields 210 identifying the municipality and state associated with the postal code. The data structure 205 may include at least one value 215 that is entered, inputted, or otherwise generated via the user interface 220. The data structure 205 may include at least one value 215 derived, determined, or otherwise generated using one or more other values 215 for other fields 210. The value 215 may be generated in accordance with the corresponding field 210. In some cases, due to an error or bug at the agent device 110 or the policy administration software, the data structure 205 may include at least one value 215 set to a null value or to a value inconsistent with the other values 215 in the data structure 205.

In some embodiments, the agent device 110 may produce, create, or otherwise generate at least one request 225 using the data structure 205. The request 225 may include or identify the data structure 205 including the set of fields 210 and the corresponding set of values 215, among others. In some embodiments, the request 225 may include information to define the policy or the data structure 205. The request 225 may include or identify, for example, the type of transaction request for the policy defined by the data structure 205, instructions to perform the transaction request, the type of policy, the type of property, the metadata associated with the data structure 205, among others. With the generation of the request 225, the agent device 110 may provide, send, or otherwise transmit the request 225 to the data processing system 105. In some embodiments, the agent device 110 may transmit the data structure 205 (e.g., independent of the request 225) to the data processing system 105.

The request handler 125 on the data processing system 105 retrieve, identify, or otherwise receive the request 225 including the data structure 205 from the agent device 110. Upon receipt, the request handler 125 may parse the request 225 to extract or identify the data structure 205 and the information included in the request 225. In some embodiments, the request handler 125 may determine or identify a type of request or the type of policy associated with the request 225 using the information included in the request 225. In some embodiments, the request handler 125 may retrieve, identify, or otherwise receive the data structure 205 (e.g., independent of the request 225) from the agent device 110. The request handler 125 may parse the data structure 205 to extract or identify the set of fields 210 and the corresponding set of values 215 therefrom. The request handler 125 may store and maintain the request 225 or the data structure 205 on the database 155.

In conjunction, the configuration manager 130 on the data processing system 105 may store and maintain a set of configurations 230A-N (hereinafter generally referred to as configurations 230) on the database 155. The set of configurations 230 (sometimes herein referred to as enumeration or configuration files) may correspond to the set of potential data types for the data structure 205. Each configuration 230 may specify, define, or otherwise identify a rule for at least one of the set of fields 210 to be checked or validated for transmission of the data structure 205 via the network 120 (e.g., to the processing device 115). The rule of the configuration 230 may also specify one or more conditions under which the data structure 205 is to be checked or validated for transmission via the network 120. The conditions may include, for example, a type of policy, a type of transaction request, a type of asset under insurance (e.g., additional vehicle, new building, or person) to the policy, among others.

In addition, the configuration 230 may define, identify, or otherwise include one or more actions to be performed on the data processing system 105 depending on the validation of the data structure 205. The actions may include, for example, permitting transmission of the data structure 205 via the network 120, restriction of the transmission of the data structure 205 from the network 120, or a provision of an indication (or error code) identifying at least one field 210 with the value 215 determined to be not valid, among others. The set of configurations 230 may be created and provided by an administrator of the data processing system 105 (or the policy administration application supported by the data processing system 105). Each configuration 230 may be stored and maintained as one or more files on the database 155. The files may include the scripts to define the configuration 230, and may include, for example, source code file (e.g., in C, Java, or python), a configuration file (e.g., extensible markup language (XML) or JavaScript Object Notation (JSON) file), and database schema file, among others.

With the receipt of the data structure 205, the configuration manager 130 may identify or select at least one configuration 230 from the set of configurations 230 based on the data type of the data structure 205. In some embodiments, the configuration manager 130 may access the database 155 to retrieve, identify, or otherwise select the configuration 230 with which to validate the data structure 205. The selection may be based on the type of policy, the type of transaction request, or the type of asset, among others. For example, when the data structure 205 is for a binding request for a new vehicle to be added to an insurance policy, the configuration manager 130 may select the configuration 230 corresponding to the binding request for new vehicles. Upon selection, the configuration manager 130 may process or parse the configuration 230 to extract or identify the rule for validating the data structure 205 for transmission via the network 120.

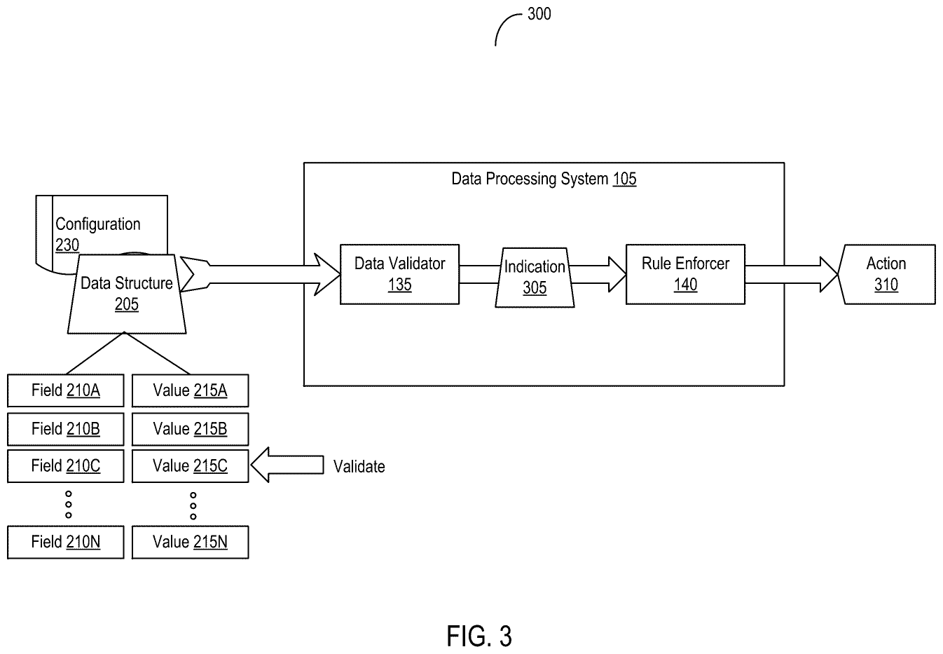

Referring now to FIG. 3, depicted is a block diagram of a process 300 for checking data against configurations in the system 100 for validating. The process 300 may include or correspond to operations performed in the system 100 to validate values in data structures defining policies. Under the process 300, the data validator 135 on the data processing system 105 may identify or determine whether to validate the data structure 205 in accordance with the configuration 230. As discussed above, the rule of the configuration 230 may specify conditions (e.g., type of policy, type of transaction request, or type of property) under which the data structure 205 is to be checked or validated for transmission via the network 120. Validation of the data structure 205 may correspond to validation of individual fields 210 and values 215 in accordance with the specifications of the configuration 230. To determine whether to validate, the data validator 135 may compare or check the data structure 205 (or the request 225) with the conditions specified by the configuration 230. When the data structure 205 matches with the conditions specified by the configuration 230, the data validator 135 may determine that the data structure 205 is to be validated. Conversely, when the data structure 205 does not match with the conditions specified by the configuration 230, the data validator 135 may determine that the data structure 205 is not to be validated. The data processing system 105 may also proceed with processing the request 225 associated with the data structure 205.

In some embodiments, if the type of request associated with the data structure 205 matches the type of request specified by the configuration 230, the data validator 135 may determine that the data structure 205 is to be validated. In contrast, if the type of request associated with the data structure 205 does not match the type of request specified by the configuration 230, the data validator 135 may determine that the data structure 205 is not to be validated. If the type of policy associated with the data structure 205 matches the type of policy specified by the configuration 230, the data validator 135 may determine that the data structure 205 is to be validated. Otherwise, if the type of policy associated with the data structure 205 matches the type of policy specified by the configuration 230, the data validator 135 may determine that the data structure 205 is not to be validated. If the type of property associated with the data structure 205 matches the type of type of property specified by the configuration 230, the data validator 135 may determine that the data structure 205 is to be validated. Else, if the type of property associated with the data structure 205 does not match the type of type of property specified by the configuration 230, the data validator 135 may determine that the data structure 205 is not to be validated. In some embodiments, the determination of whether the data structure 205 is to be validated may be omitted by the data validator 135.

When the determination that the data structure 205 is to be validated, the data validator 135 may select or identify one or more fields 210 from the set of fields 210 of the data structure 205, in accordance with the configuration 230. The configuration 230 may define or identify the one or more fields 210 for which the corresponding values 215 are to be checked for validating the data structure 205. In some embodiments, the data validator 135 may identify the field 210 corresponding to at least one of a subset of values 215 derived or generated from another value 215 that is generated via the user interface 220, in accordance with the configuration 230. In the depicted example, the configuration 230 may specify that the field 210C is to be validated, as the value 215C for the field 210C was derived from other values 215B and 215N corresponding to fields 210B and 210N respectively. The data validator 135 may identify the field 210C corresponding to the value 210C that was generated using the values 215B and 215N that were inputted via the user interface 220. For each field 210, the data validator 135 may select, find, or otherwise identify the value 215 corresponding to the field 210.

With the identification of the field 210, the data validator 135 may identify or determine whether the value 215 corresponding to the field 210 is valid. The value 215 may be determined valid, when the value 215 does not correspond to a null value (e.g., empty or zero value) or is consistent with another value 215 in the data structure 205 as identified by the configuration 230. If the value 215 correspond to a null value, the data validator 135 may determine that the value 215 for the field 210 identified by the configuration 230 is not valid. On the other hand, if the value 215 does not correspond to a null value, the data validator 135 may determine that the value 215 for the field 210 identified by the configuration 230 is valid. In some embodiments, when the value 215 is not a null value, the data validator 135 may determine whether the value 215 is consistent with other values 215 in the data structure 205.

The data validator 135 may determine whether the value 215 is valid based on consistency with other values 215 in the data structure 205. To determine consistency, the data validator 135 may identify one or more other values 215 of corresponding fields 210 in accordance with the configuration 230. The other values 215 may be reference values against a given value 215 in the data structure 205 is to be checked for consistent. In the depicted example, the other value 215 may correspond to values 215B and 215N against which to check whether the value 215C is valid, as the value 215C may be derived from the values 215B and 215N for defining the policy. The data validator 135 may generate or determine a derived value based on the one or more other values 215 of the corresponding fields 210 in the data structure 205. For instance, for a vehicle policy, the data validator 135 may determine the derived value identifying a vehicle type based on values 215 identifying make and model for a given vehicle. If the derived value matches the value 215 (e.g., the value 215C), the data validator 135 may determine that the value 215 is valid. Conversely, if the derived value does not match the value 215 (e.g., the value 215C), the data validator 135 may determine that the value 215 is invalid.

In determining whether the data structure 205 is valid, the data validator 135 may repeat the determination of whether the value 215 is valid over the one or more fields 210 identified by the configuration 230. For each field 210 identified by the configuration 230, the data validator 135 may determine whether the value 215 is valid, as detailed herein. When the value 215 of at least one field 210 identified by the configuration 230 is determined to be not valid, the data validator 135 may determine that the data structure 205 defining the policy is not valid. Conversely, when the values 215 of the fields 210 identified by the configuration 230 are all valid, the data validator 135 may determine that the data structure 205 is valid.

Based on whether the values 215 of the fields 210 identified by the configuration 230 in the data structure 205 are determined to be valid, the data validator 135 may output, produce, or otherwise generate at least one indication 305. The indication 305 may be identify whether the data structure 205 is permitted or restricted to be transmitted via then network 120 to the processing device 115. When the values 215 of the data structure 205 are determined to be valid, the data validator 135 may generate the indication 305 to identify that the data structure 205 is permitted to be transmitted to the network 120. On the other hand, when the value 215 of at least one field 210 is determined to be not valid, the data validator 135 may generate the indication 305 to identify that the data structure 205 is restricted from transmission via the network 120. The indication 305 may also identify that the restriction is due to the value 215 of at least one field 210 being determined to be invalid.

In some embodiments, the data validator 135 may generate the indication 305 to identify the at least one field 210 in the data structure 205 as corresponding to the value 215 determined to be not valid. For each field 210 corresponding to the value 215 determined to be valid, the indication 305 may include an identification of the field 210. With the generation of the indication 305, the data validator 135 may store and maintain an association of the indication 305 with the data structure 205 (or the request 225) on the database 155. The association may be stored and maintained using one or more data structures, such as a linked list, a table, a heap, a binary tree, an object, a queue, or a stack, among others.

The rule enforcer 140 on the data processing system 105 may select or identify at least one action 310 to be performed, based on the indication 305 identifying whether the data structure 205 is permitted or restricted from transmission via the network 120. In some embodiments, the identification of the action 310 may be in accordance with the configuration 230. The configuration 230 may specify which action 310 is to be taken depending on the validation of the values 215 for the fields 210 in the data structure 205. When the indication 305 identifies that the data structure 205 is permitted for transmission, the rule enforcer 140 may select the action 310 to permit the transmission of the data structure 205 to the network 120. In some embodiments, the rule enforcer 140 may select the action 310 to execute the request 225 associated with the data structure 205. Conversely, when the indication identifies that the data structure 205 is restricted from transmission, the rule enforcer 140 may select the action 310 to restrict the transmission of the data structure 205 to the network 120. In some embodiments, the rule enforcer 140 may select the action 310 to provide an identification of the fields 210 or the corresponding values 215 as invalid.

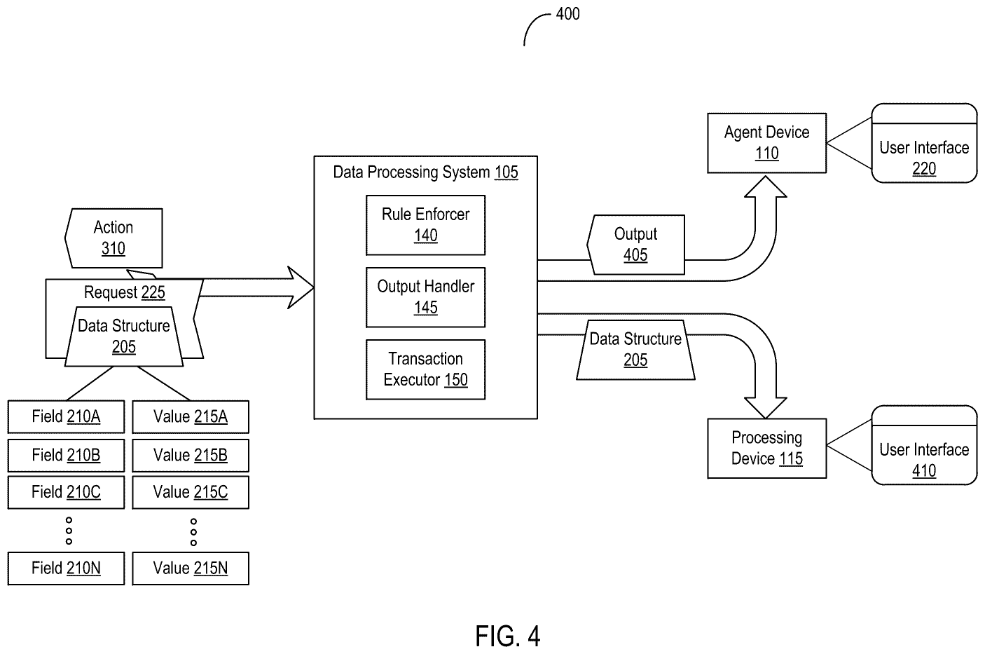

Referring now to FIG. 4, depicted is a block diagram of a process 400 for executing actions on data in the system 100 for validating. The process 400 may include or correspond to operations performed in the system 100 to perform actions in response to validation of the data structures. Under the process 400, the rule enforcer 140 may execute the action 310 identified based on the indication 305. When the action 310 is to permit transmission, the rule enforcer 140 may send, provide, or otherwise transmit the data structure 205 via the network 120 to the processing device 115. In some embodiments, the rule enforcer 140 may store and maintain an association between the data structure 205 and an identification of the action 310 to permit with the transmission, on the database 155. In this manner, when the processing device 115 (or another entity) requests for the data structure 205, the rule enforcer 140 may send the data structure 205 to the processing device 115. In some embodiments, when the action 310 identifies that the request 225 associated with the data structure 205 is to be executed, the rule enforcer 140 may also permit execution of the request 225 associated with the data structure 205.

In contrast, when the action 310 is to restrict transmission, the rule enforcer 140 may prevent, block, or otherwise restrict the transmission of the data structure 205 from the network 120. In some embodiments, the rule enforcer 140 may store and maintain an association between the data structure 205 and an identification of the action 310 to restrict the transmission, on the database 155. In this manner, when the processing device 115 (or another entity) queries for the data structure 205, the rule enforcer 140 may prevent the communication of the data structure 205 to the processing device 115. In some embodiments, the rule enforcer 140 may also prevent, block, or otherwise restrict execution of the request 225 associated with the data structure 205. In some embodiments, when the action 310 to provide an identification of the fields 210 or the corresponding values 215 as invalid, the rule enforcer 140 may identify the one or more fields 210 or the corresponding values 215 determined to be invalid.

The output handler 145 on the data processing system 105 may produce, create, or otherwise generate at least one output 405 based on the determination of whether the data structure 205 is valid, the indication 305, or the action 310. The output 405 may identify or include information to be presented via the agent device 110 (e.g., on the user interface 220). When the data structure 205 is determined to be valid, the output handler 145 may generate the output 405 to indicate that the data structure 205 is valid. In some embodiments, when the action 310 is to permit the transmission of the data structure 205, the output handler 145 may generate the output 405 to indicate that the data structure 205 is permitted to be transmitted via the network 120 (e.g., to the processing device 115). In some embodiments, the output handler 145 may generate the output 405 to indicate that the request 225 associated with the data structure 205 is permitted to be executed.

On the other hand, when the data structure 205 is determined to be not valid, the output handler 145 may generate the output 405 to indicate that the data structure 205 is not valid. In addition, the output handler 145 may generate the output 405 to include the identification of the one or more fields 210 or the corresponding values 215 determined to be not valid. For example, the output handler 145 may indicate that the value 215C is a null value or has a value that is inconsistent with values 215B and 215N. In some embodiments, when the action 310 is to restrict the transmission of the data structure 205, the output handler 405 may generate the output 405 to indicate that the data structure 205 is restricted from transmission. In some embodiments, the output handler 145 may generate the output 405 to indicate that the request 225 associated with the data structure 205 is restricted from execution. With the generation of the output 405, the output handler 145 may provide, send, or otherwise transmit the output 405 to the agent device 110.

The agent device 110 may retrieve, identify, or otherwise receive the output 405 from the data processing system 105. Upon receipt, the agent device 110 may display, render, otherwise the information included in the output 405 (e.g., via the user interface 220). For example, when the output 405 indicates that the data structure 205 is valid and permitted to be transmitted, the agent device 110 may present the indication that the data structure 205 is valid and permitted to be transmitted. Conversely, when the output 405 indicates that the data structure 205 is restricted from transmission and identifies which fields 210 or corresponding values 215 are invalid, the agent device 110 may display the indication of the data structure 205 as restricted. In addition, the agent device 110 may present an identification of the fields 210 and corresponding values 215 determined to be invalid (e.g., for having a null or inconsistent value). Through the user interface 220, the agent entity operating the agent device 110 may enter corrected information for the values 215 flagged as invalid. The agent device 110 may send the data structure 205 with the corrected information to the data processing system 105, and the process of validating the data structure 205 in accordance with the configuration 230 may be repeated.

In conjunction, the transaction executor 150 on the data processing system 105 may perform, carry out, or otherwise execute the request 225 associated with the data structure 205 defining the policy. The transaction executor 150 may execute the request 225, when the data structure 205 is determined to be valid or when the action 310 is to permit execution on the request 225. For example, if the request 225 is for a quoting request, the transaction executor 150 may carry out the quoting request (e.g., by gathering additional information and performing the risk assessment) on the policy. If the request 225 is for a binding request, the transaction executor 150 may execute the binding request (e.g., by generating information for coverage of the policy). If the request 225 is for an issuance request, the transaction executor 150 may execute the issuance request (e.g., by generating an electronic document with details regarding the policy). If the request 225 is for a claim request, the transaction executor 150 may carry out the claims request (e.g., by checking whether the conditions for the coverage have been met). With the execution, the transaction executor 150 may send, provide, or otherwise transmit at least a portion of the data structure 205 to the processing device 115. In some embodiments, the transaction executor 150 may transmit a result of the execution of the request 225, along with the data structure 205.

The processing device 115 may retrieve, identify, or otherwise receive the data structure 205 from the data processing system 105, when the data structure 205 is determined to be permitted for transmission. Upon receipt, the processing device 115 may display, render, or otherwise present information associated with the data structure 205 via a user interface 410. The user interface 410 may be part of an application to further process the policy as defined by the data structure 205. In some embodiments, the processing device 115 may receive the result of the execution of the request 225 associated with the data structure 205. The processing device 115 may present the result of the execution along with the information defining the policy.

In this manner, the data processing system 105 may control transmission flow of the data structure 205 defining the policy from the agent device 110 through the data processing system 105 toward the processing device 115. The control of the transmission flow may be configured using the set of configurations 230 specifying the conditions under which the data structure 205 is to be validated and which fields 210 and values 215 are to be validated, prior to transmission. By restricting data structure 205 with invalid values 215 from transmission, the data processing system 105 may prevent adverse effects due to such invalid values 215 from affecting other devices in the network 120, such as the processing device 115. This way, the control scheme effectuated by the data processing system 105 may reduce the wasting of computing resources on the data processing system 105 as well as the processing device 115 that would have otherwise been consumed in processing invalid data structures 205. This can also reduce the occurrence of errors or faults that would be raised in processing invalid data structures 205. Furthermore, by indicating values 215 are invalid, the data processing system 105 may improve the data integrity and data quality of the data structures 205 defining the policies. In addition, the data processing system 105 may conserve network bandwidth that would have been used in the communication of invalid data structures 205 over the network 120.

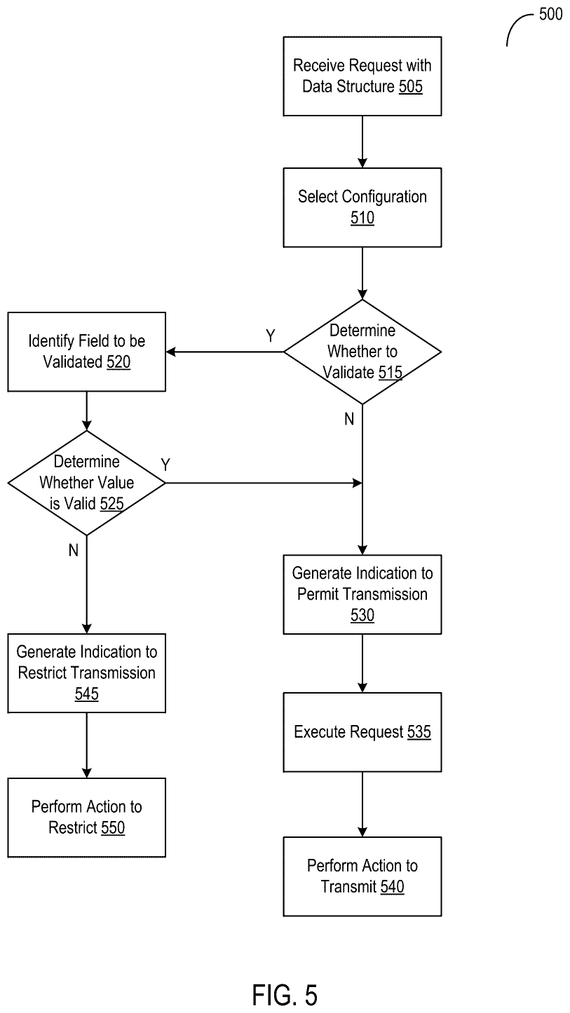

Referring now to FIG. 5, depicted is a flow diagram of a method 500 of validating data to be transmitted across networked environments. The method 500 may be performed by or implemented using any one or more components detailed herein, such as the system 100 or the system 600 of Section B. In brief overview, a computing system may receive a request including a data structure (505). The computing system may select a configuration (510). The computing system may determine whether to validate the data structure (515). If the data structure is to be validated, the computing system may identify a field to be validated (520). The computing system may determine whether the value is valid (525). If the value is valid or the data structure is not to be validated, the computing system may generate an indication to permit transmission (530). The computing system may execute the request (535). The computing system may perform an action to transmit (540). On the other hand, if the value is invalid, the computing system may generate an indication to restrict transmission (545). The computing system may perform an action to restrict (550).

In further view, a computing system may retrieve, identify, or otherwise receive a request including a data structure (505). The data structure may include a set of fields and a corresponding set of values defining a policy. Each field may correspond to a type of attribute. Each value may be associated with a corresponding field, and may include information about the type of attribute. At least one of the values may be generated via a user interface of a policy administration application. At least one of the values may not have been generated directly from the user interface, and may be derived from another value in the data structure. The data structure may be in accordance with a data type of a potential set of data types for the policy.

The computing system may identify or select a configuration based on the data type of the data structure (510). The selection may be from a set of configurations maintained on a database. Each configuration may identify a rule specifying that at least one of the set of fields is to be validated for transmission of the data structure. The rule of each configuration may also specify conditions (e.g., insurance type or request type) under which the data structure is to be validated. The computing system may select the configuration corresponding to the data type of the data structure, from the set of conditions. The computing system may identify or determine whether to validate the data structure (515). To determine, the computing system may determine whether the data structure (or the request) corresponds to the conditions defined by the configuration. When the data structure corresponds to the conditions, the computing system may determine that the data structure is to be validated. Otherwise, when the data structure does not correspond to the conditions, the computing system may determine that the data structures is not to be validated, and the associated request may be passed on for execution.

If the data structure is to be validated, the computing system may select or identify at least one field to be validated in accordance with the configuration (520). The selected configuration may identify one or more fields for which the corresponding values are to be validated. The computing system may identify or determine whether the value corresponding to the field is valid (525). To determine, the computing system may determine whether the value is null or consistent with other values in the data structure. If the value is null or inconsistent, the computing system may determine that the value is invalid. In contrast, if the value is not null and consistent, the computing system may determine that the value is valid. The computing system may repeat the functionalities of (520) and (525) over all the fields identified by the configuration as to be validated.

If the value is valid or the data structure is not to be validated, the computing system may create or generate an indication to permit transmission of the data structure (530). The computing system may generate the indication to permit the communication of the data structure to a processing device. The computing system may carry out, perform, or otherwise execute the request associated with the data structure (535). The request may be to quote or bind the policy insurance defined by the data structure. The computing system may carry out, execute, or otherwise perform an action to transmit (540). The action may include transmitting the data structure to the processing device and the result of the execution of the request.

On the other hand, if the value is invalid, the computing system may create or generate an indication to restrict transmission of the data structure (545). The computing system may generate the indication to identify the field corresponding to the value determined as invalid. The computing system may generate the indication to restrict execution of the request associated with the data structure. The computing system may carry out, execute, or otherwise perform an action to restrict (550). The computing system may perform the action to indicate to the agent entity which field and value is invalid. The computing system may also perform the action to restrict transmission of the data structure to the processing device.

### B. Computing and Network Environment

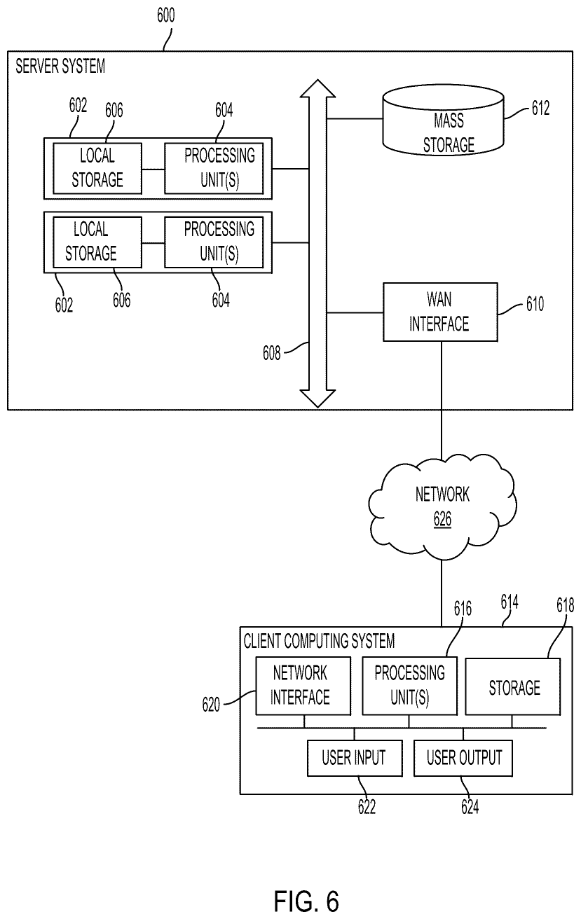

Various operations described herein can be implemented on computer systems. FIG. 6 shows a simplified block diagram of a representative server system 600, client computer system 614, and network 626 usable to implement certain embodiments of the present disclosure. In various embodiments, server system 600 or similar systems can implement services or servers described herein or portions thereof. Client computer system 614 or similar systems can implement clients described herein. The systems 100 described herein can be similar to the server system 600. Server system 600 can have a modular design that incorporates a number of modules 602 (e.g., blades in a blade server embodiment); while two modules 602 are shown, any number can be provided. Each module 602 can include processing unit(s) 604 and local storage 606.

Processing unit(s) 604 can include a single processor, which can have one or more cores, or multiple processors. In some embodiments, processing unit(s) 604 can include a general-purpose primary processor as well as one or more special-purpose co-processors such as graphics processors, digital signal processors, or the like. In some embodiments, some or all processing units 604 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 604 can execute instructions stored in local storage 606. Any type of processors in any combination can be included in processing unit(s) 604.

Local storage 606 can include volatile storage media (e.g., DRAM, SRAM, SDRAM, or the like) and/or non-volatile storage media (e.g., magnetic or optical disk, flash memory, or the like). Storage media incorporated in local storage 606 can be fixed, removable, or upgradeable as desired. Local storage 606 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 604 need at runtime. The ROM can store static data and instructions that are needed by processing unit(s) 604. The permanent storage device can be a non-volatile read-and-write memory device that can store instructions and data even when module 602 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 606 can store one or more software programs to be executed by processing unit(s) 604, such as an operating system and/or programs implementing various server functions such as functions of the system 100 or any other system described herein, or any other server(s) associated with system 100 or any other system described herein.

“Software” refers generally to sequences of instructions that, when executed by processing unit(s) 604, cause server system 600 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 604. Software can be implemented as a single program or a collection of separate programs or program modules that interact as desired. From local storage 606 (or non-local storage described below), processing unit(s) 604 can retrieve program instructions to execute and data to process in order to execute various operations described above.

In some server systems 600, multiple modules 602 can be interconnected via a bus or other interconnect 608, forming a local area network that supports communication between modules 602 and other components of server system 600. Interconnect 608 can be implemented using various technologies, including server racks, hubs, routers, etc.

A wide area network (WAN) interface 610 can provide data communication capability between the local area network (interconnect 608) and the network 626, such as the Internet. Technologies can be used, including wired (e.g., Ethernet, IEEE 802.3 standards) and/or wireless technologies (e.g., Wi-Fi, IEEE 802.11 standards).

In some embodiments, local storage 606 is intended to provide working memory for processing unit(s) 604, providing fast access to programs and/or data to be processed while reducing traffic on interconnect 608. Storage for larger quantities of data can be provided on the local area network by one or more mass storage subsystems 612 that can be connected to interconnect 608. Mass storage subsystem 612 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 612. In some embodiments, additional data storage resources may be accessible via WAN interface 610 (potentially with increased latency).

Server system 600 can operate in response to requests received via WAN interface 610. For example, one of the modules 602 can implement a supervisory function and assign discrete tasks to other modules 602 in response to received requests. Work allocation techniques can be used. As requests are processed, results can be returned to the requester via WAN interface 610. Such operation can generally be automated. Further, in some embodiments, WAN interface 610 can connect multiple server systems 600 to each other, providing scalable systems capable of managing high volumes of activity. Other techniques for managing server systems and server farms (collections of server systems that cooperate) can be used, including dynamic resource allocation and reallocation.

Server system 600 can interact with various user-owned or user-operated devices via a wide-area network such as the Internet. An example of a user-operated device is shown in FIG. 6 as client computing system 614. Client computing system 614 can be implemented, for example, as a consumer device such as a smartphone, other mobile phone, tablet computer, wearable computing device (e.g., smart watch, eyeglasses), desktop computer, laptop computer, and so on.

For example, client computing system 614 can communicate via WAN interface 610. Client computing system 614 can include computer components such as processing unit(s) 616, storage device 618, network interface 620, user input device 622, and user output device 624. Client computing system 614 can be a computing device implemented in a variety of form factors, such as a desktop computer, laptop computer, tablet computer, smartphone, another mobile computing device, wearable computing device, or the like.

Processing unit(s) 616 and storage device 618 can be similar to processing unit(s) 604 and local storage 606 described above. Suitable devices can be selected based on the demands to be placed on client computing system 614; for example, client computing system 614 can be implemented as a “thin” client with limited processing capability or as a high-powered computing device. Client computing system 614 can be provisioned with program code executable by processing unit(s) 616 to enable various interactions with server system 600.

Network interface 620 can provide a connection to the network 626, such as a wide area network (e.g., the Internet) to which WAN interface 610 of server system 600 is also connected. In various embodiments, network interface 620 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 622 can include any device (or devices) via which a user can provide signals to client computing system 614; client computing system 614 can interpret the signals as indicative of particular user requests or information. In various embodiments, user input device 622 can include any or all of a keyboard, touch pad, touch screen, mouse or other pointing device, scroll wheel, click wheel, dial, button, switch, keypad, microphone, and so on.

User output device 624 can include any device via which client computing system 614 can provide information to a user. For example, user output device 624 can include display-to-display images generated by or delivered to client computing system 614. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that functions as both input and output device. In some embodiments, other user output devices 624 can be provided in addition to or instead of a display. Examples include indicator lights, speakers, tactile “display” devices, printers, and so on.

Some embodiments include electronic components, such as microprocessors, storage, and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 604 and 616 can provide various functionality for server system 600 and client computing system 614, including any of the functionality described herein as being performed by a server or client, or other functionality.

It will be appreciated that server system 600 and client computing system 614 are illustrative and that variations and modifications are possible. Computer systems used in connection with embodiments of the present disclosure can have other capabilities not specifically described here. Further, while server system 600 and client computing system 614 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

While the disclosure has been described with respect to specific embodiments, one skilled in the art will recognize that numerous modifications are possible. Embodiments of the disclosure can be realized using a variety of computer systems and communication technologies, including, but not limited to, specific examples described herein. Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may refer to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer readable storage media; suitable media includes magnetic disk or tape, optical storage media such as compact disk (CD), or digital versatile disk (DVD), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

What is claimed is:

1. A method of validating data to be transmitted across networked environments, comprising:
receiving, by one or more processors of a policy administration system, a data structure comprising a plurality of fields and a corresponding plurality of values according to a data type of a plurality of data types for a policy, the plurality of values having a subset of values generated via a user interface provided by the policy administration system;
selecting, by the one or more processors, from a plurality of configurations corresponding to the plurality of data types, a configuration based on the data type of the data structure, the configuration identifying at least one of the plurality of fields to be validated for transmission to a network;
identifying, by the one or more processors, from the plurality of fields of the data structure, a field in accordance with the configuration;
determining, by the one or more processors, that a value of the plurality of values corresponding to the field is not valid;
generating, by the one or more processors, an indication identifying the data structure defining the policy as restricted from transmission to the network due to the value of the field, responsive to determining that the value is not valid; and
performing, by the one or more processors, an action, responsive to the indication to restrict transmission of the data structure to the network.

2. The method of claim 1, further comprising:
determining, by the one or more processors, that a second value of a second plurality of values corresponding to a second field of a second data structure defining a second policy is valid;
generating, by the one or more processors, a second indication identifying the second data structure defining the second policy as permitted to be transmitted to the network, responsive to determining that the second value is valid; and
performing, by the one or more processors, a second action, responsive to the second indication to permit transmission of the second data structure to the network.

3. The method of claim 2, wherein performing the second action further comprises:
executing a request associated with the policy, in accordance with the data structure defining the policy; and
transmitting, to a computing device, the second data structure defining the second policy.

4. The method of claim 1, wherein selecting the configuration further comprises selecting the configuration identifying a first request type for which the field of the plurality of fields is to be validated for transmission, and further comprising:
determining, by the one or more processors, that a second request type associated with the data structure matches the first request type identified by the policy, and
wherein identifying the field further comprises identifying the field, responsive to determining that the second request type matches the first request type.

5. The method of claim 1, wherein performing the action further comprises:
providing, via the user interface, the indication identifying the field of the plurality of fields corresponding to the value as invalid; and
restricting, from transmission to a computing device, transmission of the data structure defining the policy.

6. The method of claim 1, wherein receiving the data structure further comprises receiving the data structure comprising (i) the plurality of fields including (a) a first field and (b) a second field and (ii) the corresponding plurality of values including (a) a first value corresponding to the first field and (b) a second value corresponding to the second field, the first value inputted via the user interface, the second value generated using the first value in accordance with the second field.

7. The method of claim 1, wherein determining that the value is not valid further comprises:
identifying, from the plurality of values of the data structure, a second value corresponding to second field of the plurality of fields in accordance with the configuration, the second value being part of the subset of values; and
determining that the value is not valid based on consistency between the value and the second value.

8. The method of claim 1, wherein determining that the value is not valid further comprises determining that value of the plurality of values corresponds to a null value.

9. The method of claim 1, wherein identifying the field further comprise identifying, from the plurality of fields in accordance with the configuration, the field corresponding to at least one of a remaining subset of values of the plurality of values generated using one or more of the subset of values.

10. The method of claim 1, wherein receiving the data structure further comprises receiving the data structure comprising the plurality of fields and the corresponding plurality of values for the policy associated with a vehicle, the plurality of fields comprising at least one field identifying the vehicle.

11. A system for validating data to be transmitted across networked environments, comprising:
one or more processors of a policy administration system coupled with memory, the one or more processors configured to:
receive a data structure comprising a plurality of fields and a corresponding plurality of values according to a data type of a plurality of data types for a policy, the plurality of values having a subset of values generated via a user interface provided by the policy administration system;
select, from a plurality of configurations corresponding to the plurality of data types, a configuration based on the data type of the data structure, the configuration identifying at least one of the plurality of fields to be validated for transmission to a network;
identify, from the plurality of fields of the data structure, a field in accordance with the configuration;
determine that a value of the plurality of values corresponding to the field is not valid;
generate an indication identifying the data structure defining the policy as restricted from transmission to the network due to the value of the field, responsive to determining that the value is not valid; and
perform an action, responsive to the indication to restrict transmission of the data structure to the network.

12. The system of claim 11, wherein the one or more processors are further configured to:
determine that a second value of a second plurality of values corresponding to a second field of a second data structure defining a second policy is valid;
generate a second indication identifying the second data structure defining the second policy as permitted to be transmitted to the network, responsive to determining that the second value is valid; and
perform a second action, responsive to the second indication to permit transmission of the second data structure to the network.

13. The system of claim 11, wherein the one or more processors are further configured to:
select the configuration identifying a first request type for which the field of the plurality of fields is to be validated for transmission;
determine that a second request type associated with the data structure matches the first request type identified by the policy, and
identify the field, responsive to determining that the second request type matches the first request type.

14. The system of claim 11, wherein the one or more processors are further configured to:
providing, via the user interface, the indication identifying the field of the plurality of fields corresponding to the value as invalid; and
restricting, from transmission to a computing device, transmission of the data structure defining the policy.

15. The system of claim 11, wherein the one or more processors are further configured to receive the data structure comprising (i) the plurality of fields including (a) a first field and (b) a second field and (ii) the corresponding plurality of values including (a) a first value corresponding to the first field and (b) a second value corresponding to the second field, the first value inputted via the user interface, the second value generated using the first value in accordance with the second field.

16. The system of claim 11, wherein the one or more processors are further configured to determining that the value is not valid by:
identifying, from the plurality of values of the data structure, a second value corresponding to second field of the plurality of fields in accordance with the configuration, the second value being part of the subset of values; and
determining that the value is not valid based on consistency between the value and the second value.

17. The system of claim 11, wherein the one or more processors are further configured to determine that the value is not valid further comprises determining that value of the plurality of values corresponds to a null value.

18. A non-transitory computer readable medium have instructions stored thereon that, when executed by at least one processor, cause the at least one processor to perform operations comprising:
receiving a data structure comprising a plurality of fields and a corresponding plurality of values according to a data type of a plurality of data types for a policy, the plurality of values having a subset of values generated via a user interface provided by a policy administration system;
selecting, from a plurality of configurations corresponding to the plurality of data types, a configuration based on the data type of the data structure, the configuration identifying at least one of the plurality of fields to be validated for transmission to a network;
identifying, from the plurality of fields of the data structure, a field in accordance with the configuration;
determining that a value of the plurality of values corresponding to the field is not valid;
generating an indication identifying the data structure defining the policy as restricted from transmission to the network due to the value of the field, responsive to determining that the value is not valid; and
performing an action, responsive to the indication to restrict transmission of the data structure to the network.

19. The non-transitory computer readable medium storing instructions of claim 18, wherein the operations further comprise:
determining that a second value of a second plurality of values corresponding to a second field of a second data structure defining a second policy is valid;
generating a second indication identifying the second data structure defining the second policy as permitted to be transmitted to the network, responsive to determining that the second value is valid; and
performing a second action, responsive to the second indication to permit transmission of the second data structure to the network.

20. The non-transitory computer readable medium storing instructions of claim 18, wherein the operations further comprise:
selecting the configuration identifying a first request type for which the field of the plurality of fields is to be validated for transmission;
determining that a second request type associated with the data structure matches the first request type identified by the policy, and
identifying the field, responsive to determining that the second request type matches the first request type.
